(19) United States
(12) Patent Application Publication
(10) Pub. No.: US 2006/0284446 A1
(43) Pub. Date: Dec. 21, 2006

(54) Assembly of automobile body elements and method of mounting the assembly

(75) Inventors: Jerome Fillon, Lyon (FR); Gerald Andre, Amberieu en Bugey (FR)

Correspondence Address: OLIFF & BERRIDGE, PLC, P.O. BOX 19928, ALEXANDRIA, VA, 22320, US

(73) Assignee: COMPAGNIE PLASTIC OMNIUM, Lyon (FR)

(21) Appl. No.: 11/391,284

(22) Filed: Mar. 29, 2006

(30) Foreign Application Priority Data
Mar. 30, 2005 (FR) 05 03 091

(51) Int. Cl. B60J 5/00

(52) U.S. Cl. 296/146.1

(57) ABSTRACT

The assembly (1) of bodywork elements is designed to juxtapose a bodywork part (2) presenting a connection edge (3) with said assembly (1), the connection edge being curved in shape. The assembly comprises at least a first bodywork element (4) carrying a first slider member (5), and a second bodywork element (6) carrying a second slider member (7). The first and second slider members (5, 7) co-operate with each other in such a manner that the first and second bodywork elements (4, 6) are capable of sliding relative to each other while adapting to the curved shape of the connection edge (3) of the bodywork part (2).

### BACKGROUND OF THE INVENTION

Positioning an assembly of bodywork elements, such as a bumper skin, relative to a bodywork part, such as a front hood of a motor vehicle, the connecting edge between the bodywork part and the assembly being of curved shape.

In a particular circumstance, the invention enables an assembly of bodywork elements to be positioned relative to three connection edges with bodywork parts, one of the connection edges being curved in shape.

### PRIOR ART

In the prior art, a bumper skin is already known that is to be juxtaposed with a front hood of a motor vehicle, and that presents a connection edge of curved shape. The bumper skin is shaped in advance as a function of the design curved shape of the connection edge, but it is positioned in satisfactory manner only relative to the fenders of the motor vehicle.

### PROBLEM POSED BY THAT PRIOR ART

The curvature of the bumper skin, once secured on the motor vehicle, rarely corresponds exactly to the shape of the connection edge of the hood, in particular because it depends on the width between the fenders of the motor vehicle, which width is not constant from one vehicle to another.

### SUMMARY OF THE INVENTION

The invention seeks to facilitate positioning the assembly relative to the bodywork part by providing an assembly of motor vehicle bodywork elements that is to juxtapose a bodywork part via a connection edge of said part, which edge is curved in shape, wherein the assembly comprises at least a first bodywork element carrying a first slider member, and a second bodywork element carrying a second slider member co-operating with the first slider member in such a manner that the first and second bodywork elements are capable of sliding relative to each other while adapting to the curved shape of the connection edge of the bodywork part.

Thus, by means of the invention, it is possible in simple manner to adapt the assembly to the curved shape of the connection edge, by causing the bodywork elements to slide relative to one another in order to obtain the desired general shape.

### ADVANTAGEOUS PARTICULAR EMBODIMENTS

The assembly includes locking means for locking the bodywork elements together, the locking means serving, when activated, to oppose the sliding of said bodywork elements relative to each other. The bodywork elements are thus held in position. Furthermore, the locking means also make it possible to prevent the bodywork elements from vibrating and moving relative to one another due to impacts or to sunshine.

The assembly extends between first and second lateral ends, each designed to be arranged close to a respective fender of the motor vehicle.

Each side end of the assembly includes means for positioning the assembly relative to the corresponding fender of the motor vehicle.

The first bodywork element is flexible about a direction that is vertical when considering the assembly in position on the motor vehicle.

Each side end carries fastener means for fastening to the motor vehicle.

For motor vehicle fenders spaced apart from each other by a given distance, the assembly prior to mounting extends over a length that is greater than the distance between the motor vehicle fenders.

At least one of the bodywork elements carries a light unit.

At least one of the bodywork elements comprises a glass for a light. This lateral element is optionally connected to technical elements of the light via a gasket.

The assembly includes two side elements carrying fastener means for fastening to the motor vehicle, and a central element suitable for sliding relative to each of the side elements.

The assembly constitutes a bumper skin.

The assembly is designed to be adjacent to a front hood of a motor vehicle.

The invention also provides a method of mounting a bodywork element assembly of the invention, the method comprising the following steps:
fastening two side elements of the assembly to the motor vehicle;
causing the elements of the assembly to slide relative to one another into a position in which the assembly and the bodywork part of the motor vehicle are suitably positioned relative to each other; and
locking the elements of the assembly in said position so that they no longer slide relative to one another.

Optionally, prior to fastening the side ends of the assembly on the motor vehicle, the side ends are positioned by being put into position relative to the fenders of the motor vehicle.

### BRIEF DESCRIPTION OF THE DRAWINGS

An example of an assembly of the invention of bodywork elements is shown in diagrammatic FIGS. 1 to 4 which present no limiting character on the scope of the invention.

FIGS. 1 to 4 are plan views of a bodywork element assembly of the invention during successive steps in the method of mounting the assembly on the motor vehicle.

### DETAILED DESCRIPTION OF THE PREFERRED EMBODIMENT

| | Specific in the | Reference in the |
|---|---|---|
| General term | example | drawings |
| Bodywork element | Bumper skin | 1 |
| assembly | | |
| Bodywork part | Motor vehicle | 2 |
| | front hood | |
| Connection edge | Connection edge | 3 |
| First bodywork | Central element | 4 |
| element | | |
| First slider | First slider | 5 |
| member | member | |
| Second bodywork | Side element | 6 |
| element | | |
| Second slider | Second slider | 7 |
| member | member | |
| Side ends | Side ends | 8 |
| Motor vehicle | Motor vehicle | 9 |
| fenders | fenders | |
| Means for | Means for | 10 |
| fastening to the | fastening to the | |
| motor vehicle | motor vehicle | |
| Light unit | Light unit | 11 |

Details of Examples

| Reference | Explanation |
|---|---|
| 1 | The assembly of bodywork elements forms a |
| | bumper skin. |
| 2 | The front hood of the motor vehicle presents |
| | a connection edge 3 with the assembly 1 that |
| | is curved in shape. |
| 3 | The connection edge between the assembly 1 |
| | and the hood 2 is curved in shape. The |
| | assembly 1 must adapt to this curved shape. |
| 4 | The central assembly element 1 is flexible |
| | so as to adapt as well as possible to the |
| | curved shape of the connection edge 3. |
| 5 | The two first slider members are designed to |
| | co-operate with respective ones of the two |
| | second slider members 7 so that the central |
| | element 4 slides relative to the side |
| | elements 6. |
| 6 | Each of the two side elements carries |
| | fastener means 10 for fastening to the motor |
| | vehicle and relative positioning means (not |
| | shown) for positioning relative to the motor |
| | vehicle fenders 9. |
| 7 | There are locking means (not shown) for |
| | opposing sliding of the slider members |
| | relative to one another, once said locking |
| | means have been activated. |
| 10 | Means for fastening the assembly 1 to the |
| | motor vehicle and carried by the side |
| | elements 6. |
| 11 | Light units, carried by the side elements 6. |

General Explanations

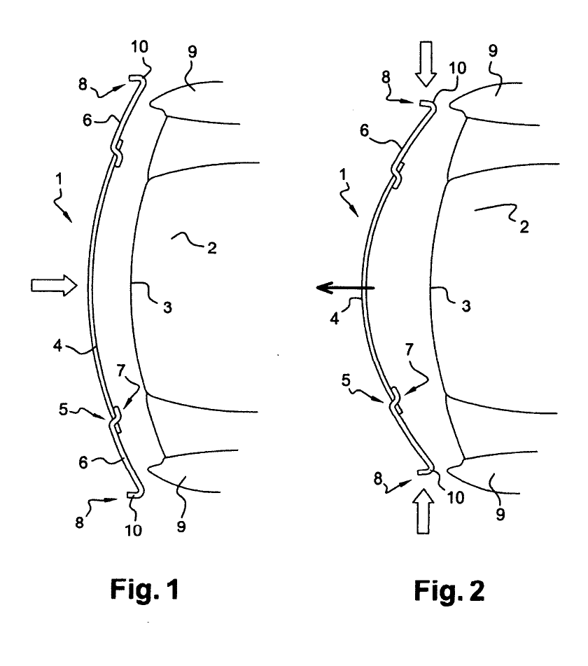

FIG. 1 shows the assembly 1 prior to mounting. It can be seen that the length of the assembly 1 is longer than the distance between the fenders 9 of the motor vehicle. It is thus possible to bow the assembly 1 in order to adapt it to fit the shape of the connection edge 3.

In FIG. 2, the central element 4 is bowed in such a manner that the distance between the side ends 8 is the same as the distance between the fenders 9. The side ends 8 can thus be fastened to the motor vehicle, close to the fenders 9. The side ends 8 are preferably positioned relative to the fenders 9 by relative positioning means that are not shown.

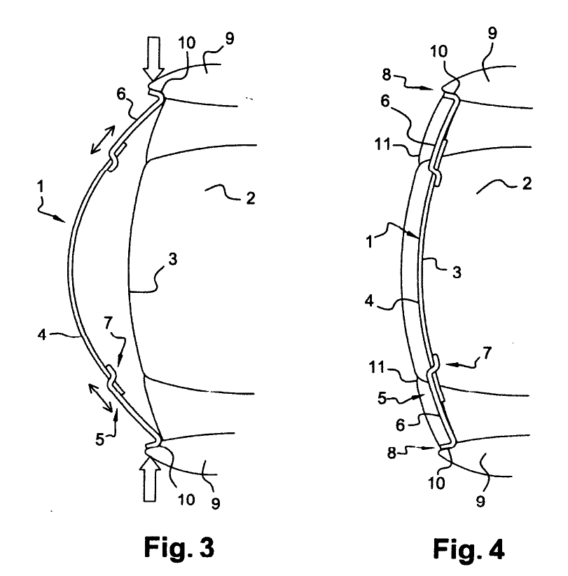

In FIG. 3, the central element 4 is caused to slide relative to the side elements 6 so as to obtain a position, as shown in FIG. 4, in which the assembly 1 and the hood 2 are suitably positioned relative to each other.

When the elements 4 and 6 of the assembly 1 are in this position, they are locked in this position by the locking means.

The assembly 1 thus juxtaposes all of the adjacent bodywork parts (fenders, hood) in satisfactory manner.

Generalizations or Possible Alternatives

The assembly could comprise any number of elements capable of sliding relative to one another, with the number of elements being not less than two.

Furthermore, the assembly may form a bodywork element other than a bumper skin.

1. An assembly of motor vehicle bodywork elements for juxtaposing with a bodywork part that presents a connection edge with said assembly, the connection edge being curved in shape, wherein the assembly comprises at least a first bodywork element carrying a first slider member, and a second bodywork element carrying a second slider member co-operating with the first slider member in such a manner that the first and second bodywork elements are capable of sliding relative to each other while adapting to the curved shape of the connection edge of the bodywork part.

2. A bodywork element assembly according to claim 1, including locking means for locking the bodywork elements together, the locking means serving, when activated, to oppose the sliding of said bodywork elements relative to each other.

3. A bodywork element assembly according to claim 1, the assembly extending between two lateral ends, each designed to be disposed close to a respective fender of the motor vehicle.

4. A bodywork element assembly according to claim 3, wherein each side end of the assembly includes means for positioning the assembly relative to the corresponding fender of the motor vehicle.

5. A bodywork element assembly according to claim 1, wherein the first bodywork element is flexible about a direction that is vertical when considering the assembly in position on the motor vehicle.

6. A bodywork element assembly according to claim 3, wherein each side end carries fastener means for fastening to the motor vehicle.

7. A bodywork element assembly according to claim 3, wherein, for motor vehicle fenders spaced apart from each other by a given distance, the assembly prior to mounting extends over a length that is greater than the distance between the motor vehicle fenders.

8. A bodywork element assembly according to claim 1, wherein at least one of the bodywork elements carries a light unit.

9. A bodywork element assembly according to claim 1, wherein at least one of the bodywork elements comprises a glass for a light.

10. A bodywork element assembly according to claim 1, the assembly having two side elements carrying fastener means for fastening to the motor vehicle, and a central element suitable for sliding relative to each of the side elements.

11. A bodywork element assembly according to claim 1, the assembly comprising a bumper skin.

12. A bodywork element assembly according to claim 1, for juxtaposing with a front hood of a motor vehicle.

13. A method of mounting a bodywork element assembly according to claim 1, the method comprising the following steps:
fastening two side elements of the assembly to the motor vehicle;
causing the elements of the assembly to slide relative to one another into a position in which the assembly and the bodywork part of the motor vehicle are suitably positioned relative to each other; and
locking the elements of the assembly in said position so that they no longer slide relative to one another.

14. A mounting method according to claim 13, wherein, prior to fastening the side ends of the assembly on the motor vehicle, the side ends are positioned by being put into position relative to the fenders of the motor vehicle.
